(19) United States
(12) Patent Application Publication
(10) Pub. No.: US 2018/0361665 A1
(43) Pub. Date: Dec. 20, 2018

(54) 3D Printing Method and Apparatus

(71) Applicant: Aurora Labs Limited, Bibra Lake WA (AU)

(72) Inventor: David Budge, Applecross, Western Australia (AU)

(73) Assignee: Aurora Labs Limited, Bibra Lake WA (AU)

(21) Appl. No.: 16/063,318

(22) PCT Filed: Dec. 5, 2016
(86) PCT No.: PCT/AU2016/000389

§ 371 Date: Jun. 18, 2018

(30) Foreign Application Priority Data
Dec. 18, 2015 (AU) 2015905271

(51) Int. Cl. B29C 64/268; B29C 64/214; B29C 64/153; B29C 64/329; G02B 27/10

(52) U.S. Cl. CPC B29C 64/268; B29C 64/214; B33Y 30/00; B29C 64/329; G02B 27/1066; B29C 64/153

(57) ABSTRACT

A printing apparatus is for printing a three-dimensional object, comprising an operative surface, an energy source for emitting at least one energy beam onto the operative surface and at least one supply hopper for dispensing powder onto the operative surface, wherein the powder is adapted to be melted by the energy beam. The supply hopper is configured such that powder being dispensed by the supply hopper has an airborne density when travelling from the supply hopper to the operative surface, and wherein the density provides that the powder is not melted by the energy beam when the powder is travelling to the operative surface.

### FIELD OF INVENTION

The present invention relates to a 3D printing method and apparatus.

More particularly, the present invention relates to a 3D printing method and apparatus adapted for manufacturing objects at high speed.

### BACKGROUND ART

Three-dimensional (3D) printed parts result in a physical object being fabricated from a 3D digital image by laying down consecutive thin layers of material.

Typically these 3D printed parts can be made by a variety of means, such as selective laser melting or sintering, which operate by having a powder bed onto which an energy beam is projected to melt the top layer of the powder bed so that it welds onto a substrate or a substratum. This melting process is repeated to add additional layers to the substratum to incrementally build up the part until completely fabricated.

These printing methods are significantly time consuming to perform and it may take several days, or weeks, to fabricate a reasonable sized object. The problem is compounded for complex objects comprising intricate component parts. This substantially reduces the utility of 3D printers and is one of the key barriers currently impeding large-scale adoption of 3D printing by consumers and in industry.

The present invention attempts to overcome, at least in part, the aforementioned disadvantages of previous 3D printing methods and devices.

### SUMMARY OF THE INVENTION

In accordance with one aspect of the present invention, there is provided a printing apparatus for printing a three-dimensional object, comprising:
an operative surface;
an energy source for emitting at least one energy beam onto the operative surface; and
at least one supply hopper for dispensing powder onto the operative surface, the powder being adapted to be melted by the energy beam,
   wherein the supply hopper is configured such that powder being dispensed by the supply hopper has an airborne density when travelling from the supply hopper to the operative surface, and wherein the density provides that the powder is not melted by the energy beam when the powder is travelling to the operative surface.

The printing apparatus may comprise an energy beam splitting means for splitting the energy beam into a plurality of separate energy beams and directing each separate energy beam onto a common focus.

The printing apparatus may comprise a plurality of energy sources for emitting a plurality of energy beams through the powder being dispensed and onto the operative surface, wherein the energy beams are each directed onto a common focus.

The printing apparatus may comprise a plurality of supply hoppers for dispensing powder onto the operative surface.

The apparatus may comprise a scanning means for determining a position, velocity and/or size of one or more particles comprised in the powder when the, or each, particle is travelling from the supply hopper to the operative surface.

The scanning means may be adapted to measure the airborne density of the powder.

The scanning means may be adapted to measure a volume of powder deposited on the operative surface.

The scanning means may be adapted to measure a level of the powder deposited on the operative surface.

The apparatus may comprise a levelling means for substantially levelling powder deposited on the operative surface.

The supply hopper may be configured to give each particle comprised in the powder a velocity when leaving the supply hopper, wherein the velocity provides that the particles settle onto the operative surface in a substantially level manner.

Each particle velocity may have a speed and direction that accords to a pre-determined scattering algorithm.

The scattering algorithm may incorporate a stochastic-based selection process.

The scattering algorithm may incorporate a pseudorandom-based selection process.

The levelling means may comprise a blade that, in use, periodically scrapes an upper surface of the powder on the operative surface.

The levelling means may comprise an electrostatic charging means.

The levelling means may comprise a vibration generation means for applying vibrational forces to particles comprised in the powder on the operative surface.

The vibration generation means may comprise a mechanical vibration generator.

The vibration generation means may comprise an ultra-sonic vibration generator.

In accordance with one further aspect of the present invention, there is provided a method for printing a three-dimensional object, the method comprising the steps of:
using a supply hopper to dispense powder onto an operative surface, wherein the powder has a density when travelling airborne from the supply hopper to the operative surface; and
using an energy source to emit an energy beam through the powder being dispensed and onto the operative surface,
   wherein the density provides that the powder is not melted when travelling from the supply hopper to the operative surface.

### BRIEF DESCRIPTION OF DRAWINGS

The present invention will now be described, by way of example, with reference to the accompanying drawings, in which:

FIG. 1 is a side schematic view of a conventional 3D printing apparatus known in the art;

FIG. 2 is a side schematic view of a 3D printing apparatus according to a first embodiment of the present invention;

FIG. 3 is a side schematic view of a 3D printing apparatus according to a second embodiment of the present invention;

FIG. 4 is a side schematic view of a 3D printing apparatus according to a third embodiment of the present invention; and

FIG. 5 is a side schematic view of a 3D printing apparatus according to a fourth embodiment of the present invention.

### DETAILED DESCRIPTION OF THE DRAWINGS

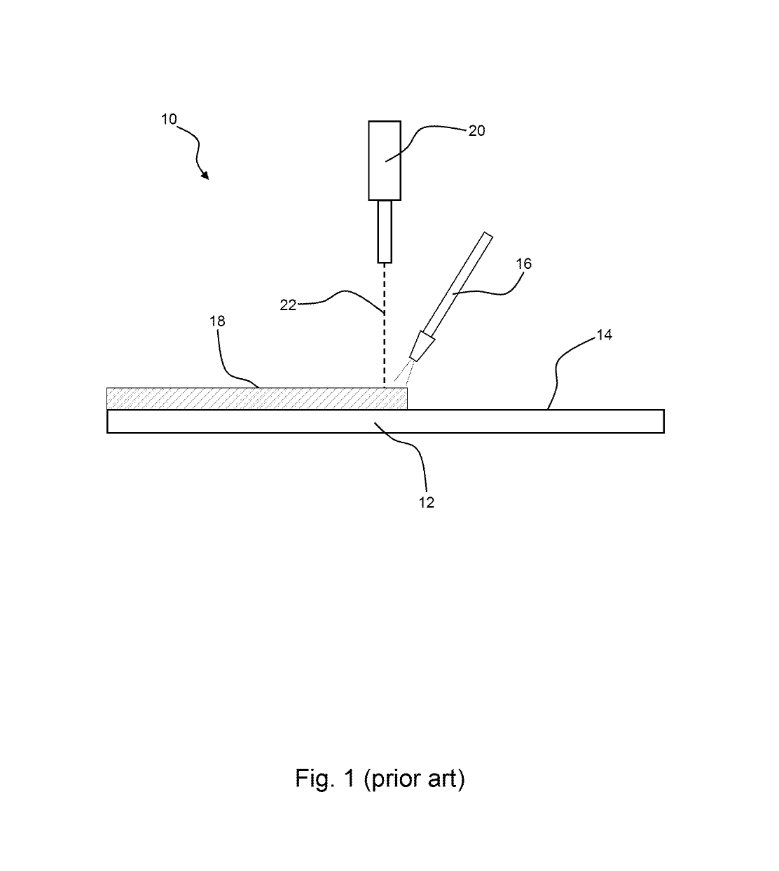

Referring to FIG. 1, there is shown a schematic representation of a conventional 3D printing apparatus 10 known in the art. The apparatus 10 comprises a substrate 12 with an operative surface 14 on which a printed object is to be fabricated by 3D printing.

The apparatus 10 further comprises a supply hopper 16 that deposits a single layer of powder 18 onto the operative surface 14.

An energy gun 20 (commonly a laser or electron gun) emits an energy beam 22 onto the layer of powder 18 causing it to melt or sinter selectively to form an individual layer of the 3D object. The process is repeated to add additional layers and incrementally build up the object until it is completed.

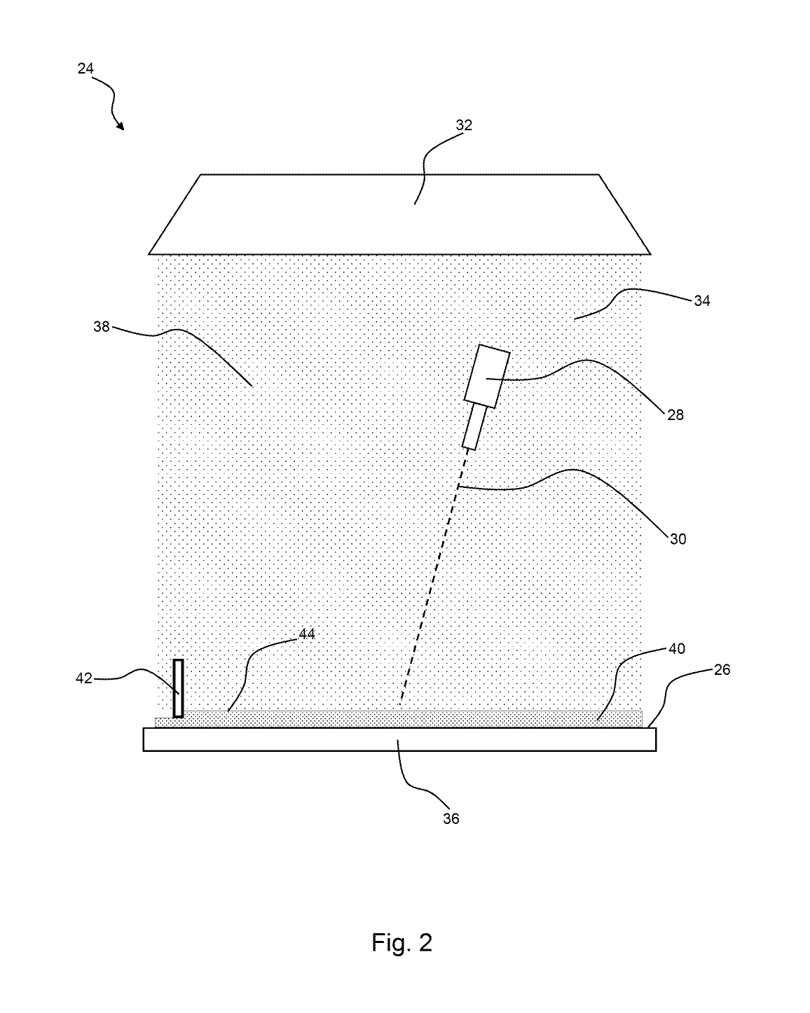

Referring to FIG. 2, there is shown a schematic representation of a 3D printing method and apparatus 24 according to a first embodiment of the present invention.

The apparatus 24 comprises an operative surface 26, an energy source 28 for emitting at least one energy beam 30 onto the operative surface 26 and at least one supply hopper 32 for dispensing powder 34 onto the operative surface 26, the powder 34 being adapted to be melted by the energy beam 30. The supply hopper 32 is configured such that powder 34 being dispensed by the supply hopper 32 has an airborne density when travelling from the supply hopper 32 to the operative surface 26, and wherein the density provides that the powder 34 is not melted by the energy beam 30 when the powder is travelling to the operative surface 26.

More particularly, the apparatus 24 comprises a substrate 36 forming the operative surface 26 on which a printed object is to be fabricated by 3D printing. The apparatus 24 comprises a single large supply hopper 32. The powder 34 is dispensed from the supply hopper 32 in a continuous manner and precipitates in a generally downwards direction onto the operative surface 26.

In use, while traveling from the supply hopper 32 to the operative surface 26, the powder 34 is airborne and forms a dynamic particulate volume 38 that is substantially columnar A control means (not shown) controls the volumetric flow rate of the powder 34 that is dispensed by the supply hopper 32 and ensures that the particulate volume 38 has a substantially uniform density that conforms to a specified value, or that substantially stays within a specified density range.

When the powder 34 settles onto the operative surface 26, the powder 34 forms a layer 40. The thickness of the layer 40 increases in a continuous manner as further powder 34 is supplied by the hopper 32 and precipitates onto the top surface of the layer 40.

The apparatus 24 further comprises an energy source which, in the first embodiment of the invention shown in FIG. 1, comprises a single energy gun 28 for emitting an energy beam 30. The energy gun 28 is arranged such that its energy beam 30 passes through the airborne powder 34 and is directed onto the operative surface 26 or incumbent topmost powder layer 40.

The energy beam 30 melts or sinters the powder layer 40 selectively to form part of the 3D object being fabricated. This process continues as further powder 34 precipitates onto the layer 40 thereby incrementally forming the 3D object until printed in full.

The selected density, or density range, of the airborne powder 34 ensures that the energy beam 30 does not melt, or have any adverse or unwanted influence on, the airborne powder 34 when traveling from the supply hopper 30 to the operative surface 26.

In contrast to the prior art 3D printing apparatus 10 shown in FIG. 1, wherein layers of powder are applied individually, the present invention provides an uninterrupted supply of powder that can be selectively melted or sintered in a continuous manner This advantageously leads to a substantial increase in printing productivity.

The energy source used in the invention can be any one of a laser beam, a collimated light beam, a micro-plasma welding arc, an electron beam, a particle beam or other suitable energy beam.

In embodiments of the invention that make use of electron beam energy sources, the printing apparatus 24 (including the operative surface 26) may be contained and operated wholly inside a vacuum chamber to facilitate propagation of the electron beam onto the layers of powder.

The effectiveness of the present invention substantially relies on the powder layer 40 being formed onto the operative surface 26 in a controlled manner. It is, in particular, important that the layer 40 formed has uniform thicknesses and has a top surface that is substantially level when being worked on by the energy source.

Due to the nature of powder particles, they often tend to roll across the operative surface 26 when deposited thereon. This is normally either due to the shape of the powder particles, e.g. roughly round shaped powder particles that bounce roll on the operative surface 26 and collide with other powder particles already located thereon, or the rolling can be caused by the force of the gas feed carrying the powder particles from the powder supply 30, or the rolling can be caused by gravity by the powder particles rolling off a “heap” if too many powder particles are deposited at the same position.

It is also known that the thickness of a layer of powder 36 can be reduced after the layer has been worked on by the energy source due to, for example, particle shrinkage. The reduction in thickness may detrimentally affect powder subsequently deposited by the supply hopper 30 and/or the resultant 3D object that is fabricated.

The apparatus 24, therefore, additionally comprises a levelling means for periodically levelling the powder layer 40 during operation.

In the embodiment disclosed in FIG. 2, the levelling means comprises a blade 42 that, in use, is periodically scraped over the top surface 44 of the layer of powder 40 in order to modify its thickness, as may be necessary, and to ensure that its top surface is kept substantially level.

The blade 42 is controlled using mechanical control means and control electronics (not shown) driven by software or firmware implementing an algorithm for controlling the position, speed and orientation of the blade 42.

The algorithm implemented causes the blade 42 to operate selectively on the powder layer 40 as the layer 40 is formed incrementally, and in concert with the energy gun 28.

Instead of or in addition to the blade 42, the levelling means used by the apparatus 24 may comprise a vibration generation means (not shown) for applying vibrational forces to the layer of powder 36. These vibrational forces cause individual particles in the powder layer 40 to vibrate and become dynamic. The vibrational forces may be applied selectively causing the particles to form and settle into a desired arrangement.

The vibration generation means used by the apparatus 24 may be a mechanical vibration generator or, alternatively, an ultra-sonic vibration generator.

Further, instead of or in addition to the blade and/or vibration generation means, the levelling means may comprise an electrostatic charging means which electrostatically charges both the powder particles and the operative surface 26 with opposed polarities.

For example, a positive charge can be applied to the operative surface 26 and the powder particles 32 exiting the supply 30 can be negatively charged. Thus, as the powder particles 32 exit the supply 30 they are drawn towards the operative surface 26 and, once contact is made therewith, the powder particles stick in place on the operative surface 26.

Advantages of such adhesion is, firstly, that it results in an improved resolution of the final component as the powder particles can be accurately placed and, secondly, that working environment within the printing apparatus 24 is improved as there is less powder particle dust between the supply 30 and the operative surface 26. Further, it is also possible to control the direction of flow of the electrostatically charged powder particles using other electrostatic means.

Further, instead of or in addition to the blade 42, vibration generation and/or electrostatic charging means, individual particles comprised in the powder 34 may be given a specific velocity when ejected from the supply hopper 30.

Preferably, each particle will be given a velocity that has a speed and direction according to a pre-determined scattering algorithm.

Preferably, the scattering algorithm incorporates a stochastic or pseudo-random based selection process.

The velocities given to the particles cause them to settle onto the operative surface 26 in a substantially uniform and level manner by virtue of inertial exchanges and other physical interactions that take place when the particles impact the operative surface 26 and/or incumbent powder layer 40.

To enable the apparatus 24 to control the volumetric flow rate and density of airborne powder 34 and the levelling means described above, the apparatus 24, preferably, also comprises a scanning means (not shown).

The scanning means is, preferably, adapted to determine a position, velocity and/or size of one or more particles comprised in the powder 34 when the, or each, particle is travelling from the supply hopper 30 to the operative surface 26.

The scanning means is, preferably, also adapted to measure the airborne density of the powder 34.

The scanning means is, preferably, also adapted to measure a volume of powder deposited on the operative surface 26.

The scanning means is, preferably, also adapted to measure a level of the powder deposited on the operative surface 26.

The scanning means may make use of an ultra-sonic, laser or other appropriate known scanning or positioning technology.

Information and data collected using the scanning means is used, in conjunction with control electronics and software, to determine the volumetric flow rate, direction and/or velocity of powder emitted from the supply hopper 30 and/or the direction and intensity of the energy beam 30 to optimise fabrication of the part being printed.

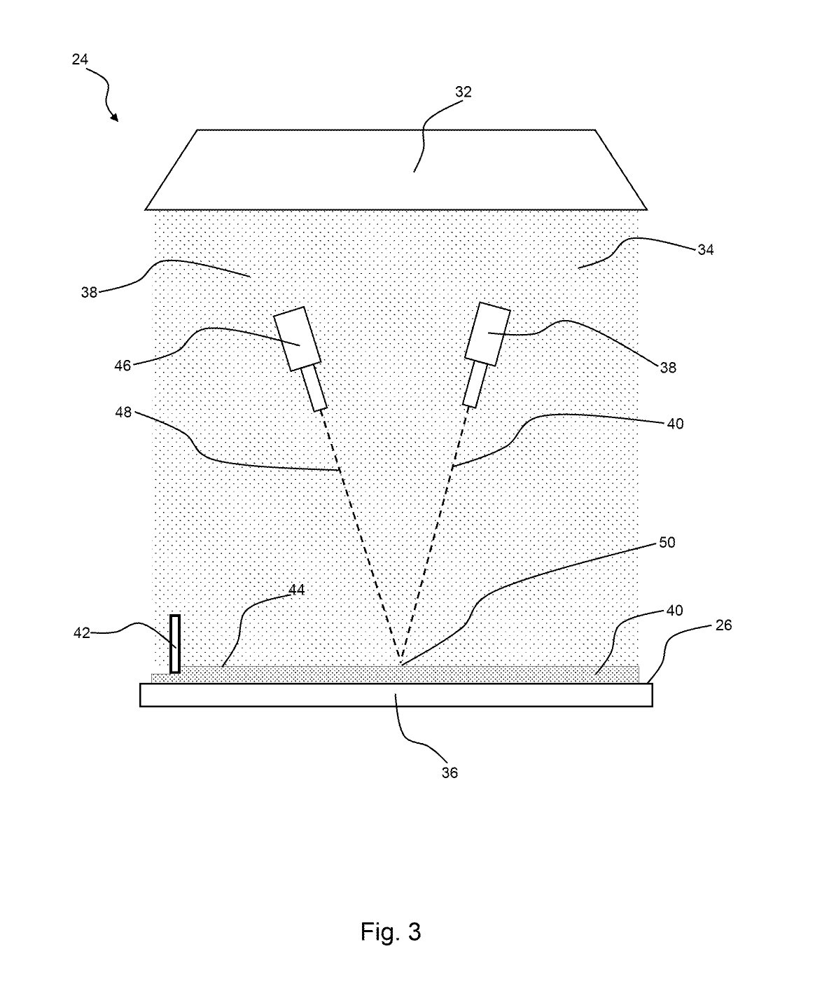

Referring to FIG. 3, there is shown a schematic representation of a 3D printing method and apparatus 24 according to a second embodiment of the present invention. The embodiment disclosed is identical in all respects to the first embodiment disclosed in FIG. 2 save that the energy source comprises an additional energy gun 46 for emitting a second energy beam 48 through the airborne powder 34 onto the operative surface 26.

The two energy guns 38,46 are adapted such that their respective energy beams 40,48 are directed onto a common focal point 50 on the operative surface 26 or powder layer 40. In this arrangement, the combined energy emitted by the energy guns 38,46 onto the focal point 50 is sufficient to melt or sinter the powder layer 40 and form part of the 3D object being fabricated at the focal point 50. The respective energy beams 40,48 emitted by the energy guns 38,46 are, however, not, individually, sufficiently powerful to melt, or have any adverse or unwanted influence on, the airborne powder 34.

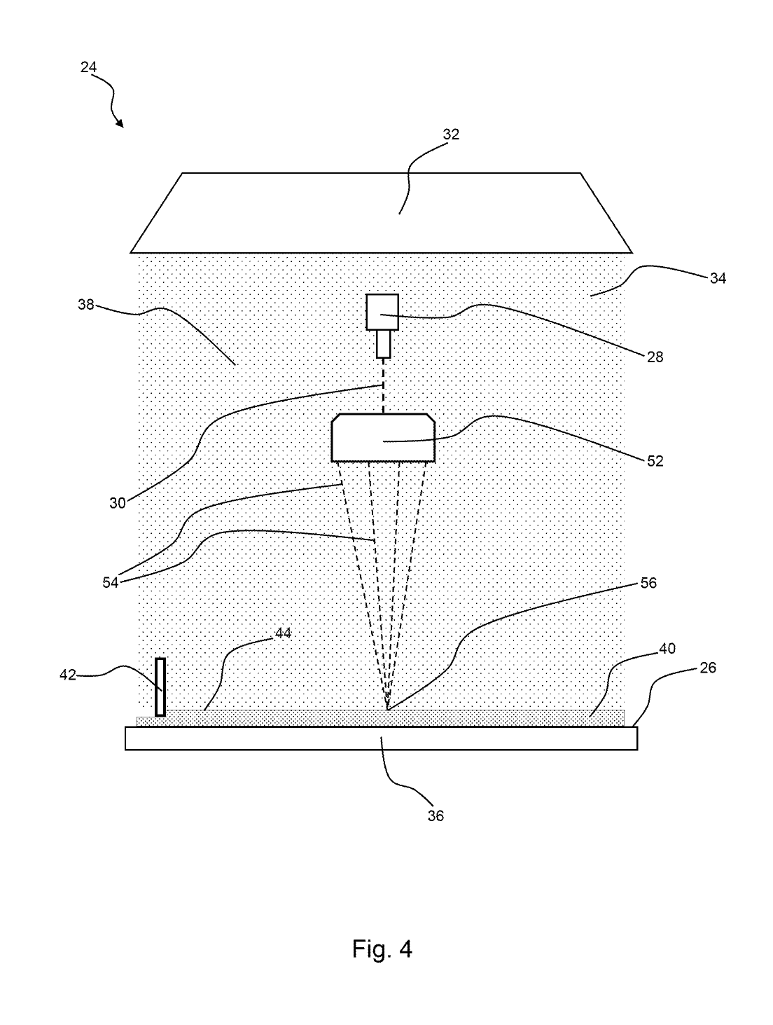

Referring to FIG. 4, there is shown a schematic representation of a 3D printing method and apparatus 24 according to a third embodiment of the present invention. The embodiment disclosed is identical in all material respects to the first embodiment disclosed in FIG. 2 save that the energy source also comprises an energy beam splitting means 52.

The energy beam splitting means 52 splits the single energy beam 30 emitted by a single energy gun 28 into a plurality of directed energy beams 54. The energy beam splitting means 52 operates in conjunction with a control mechanism (not shown) which ensures that the directed energy beams 54 emitted from the energy beam splitting means 52 are each directed onto a common focal point 56 on the operative surface 26 or powder layer 40. In this arrangement, the combined energy emitted by the directed energy beams 54 onto the focal point 56 is sufficient to melt or sinter the powder and form part of the 3D object being fabricated at the focal point 56.

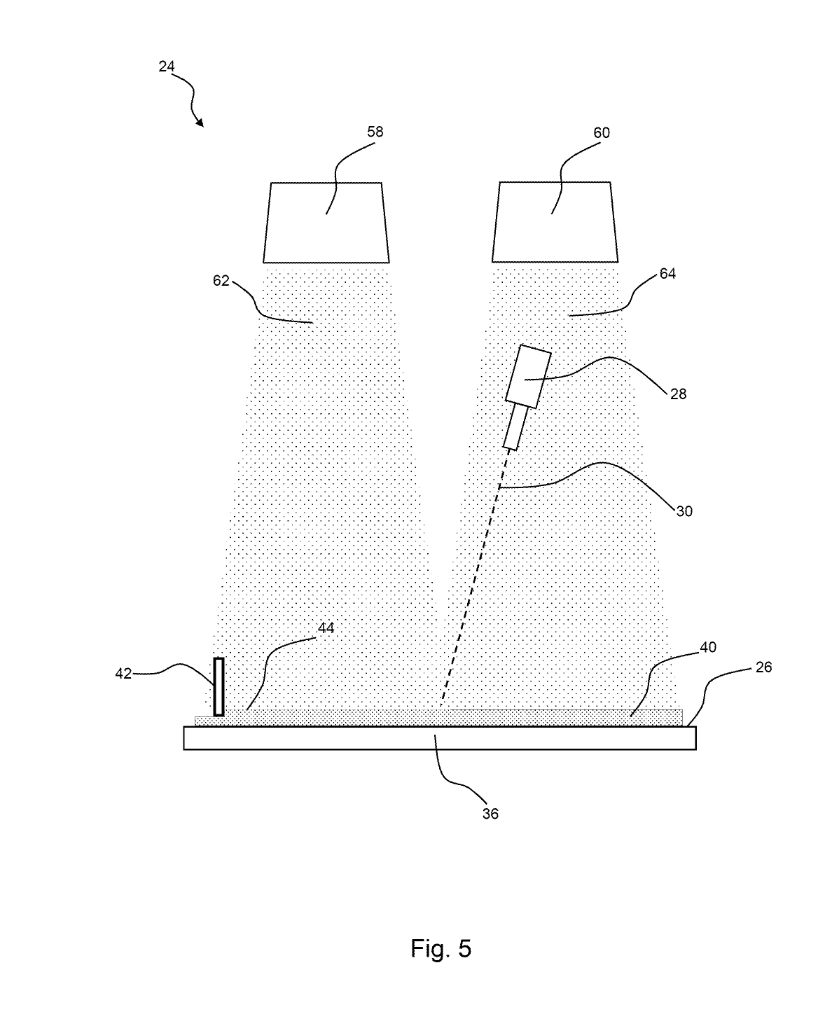

Referring to FIG. 5, there is shown a schematic representation of a 3D printing method and apparatus 24 according to a fourth embodiment of the present invention. The embodiment disclosed is identical in all material respects to the first embodiment disclosed in FIG. 2 save that the apparatus 24 comprises a plurality of supply hoppers 58,60 for dispensing powder onto the operative surface 26. Whilst a first 58 and a second 60 supply hopper is shown in the Figure, it will be appreciated that an alternative number of supply hoppers may be used.

The two supply hoppers 58,60 are each adapted to dispense powder onto the operative surface 26 in the same manner as described above for the first embodiment of the invention disclosed in FIG. 2. The two hoppers 58,60 are, however, further adapted such that the first and second columns of dynamic powder 62,64 that are formed cause powder to be precipitated onto the operative surface 26 in a substantially uniform and controlled manner, thereby forming a singular even layer of powder 40.

Further modifications and variations as would be apparent to a skilled addressee are deemed to be within the scope of the present invention.

In the preceding description of the invention and the following claims, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

1. A printing apparatus for printing a three-dimensional object, comprising:
an operative surface;
an energy source for emitting at least one energy beam onto the operative surface; and
at least one supply hopper for dispensing powder onto the operative surface, the powder being adapted to be melted by the energy beam upon reaching the surface,
wherein the supply hopper is configured such that powder is dispensed evenly to form a bed upon the operative surface, and wherein the energy source is configured to move independently of the supply hopper, and wherein the supply hopper is configured such that powder being dispensed by the supply hopper has an airborne density when travelling from the supply hopper to the operative surface, and wherein the density provides that the powder is not melted by the energy beam when the powder is travelling to the operative surface.

2. The printing apparatus according to claim 1, wherein the apparatus comprises a plurality of energy sources for emitting a plurality of energy beams through the powder being dispensed and onto the operative surface, wherein the energy beams are each directed onto a common focus.

3. The printing apparatus according to claim 1, wherein the apparatus further comprises an energy beam splitting means for splitting the energy beam into a plurality of separate energy beams and directing each separate energy beam onto a common focus.

4. The printing apparatus according to claim 1, wherein the apparatus comprises a plurality of supply hoppers for dispensing powder onto the operative surface.

5. The printing apparatus according to claim 1, wherein the apparatus further comprises a scanning means for determining a position, velocity and/or size of one or more particles comprised in the powder when the, or each, particle is travelling from the supply hopper to the operative surface.

6. The printing apparatus according to claim 5, wherein the scanning means is adapted to measure the airborne density of the powder.

7. The printing apparatus according to claim 5, wherein the scanning means is adapted to measure a volume of powder deposited on the operative surface.

8. The printing apparatus according to claim 5, wherein the scanning means is adapted to measure a level of the powder deposited on the operative surface.

9. The printing apparatus according to claim 1, wherein the supply hopper is configured to give each particle comprised in the powder a velocity when leaving the supply hopper, wherein the velocity provides that the particles settle onto the operative surface in a substantially level manner.

10. The printing apparatus according to claim 9, wherein the supply hopper is configured such that each particle velocity has a speed and direction that accords to a pre-determined scattering algorithm.

11. The printing apparatus according to claim 10, wherein the scattering algorithm incorporates a stochastic-based selection process.

12. The printing apparatus according to claim 10, wherein the scattering algorithm incorporates a pseudorandom-based selection process.

13. The printing apparatus according to claim 1, wherein the apparatus further comprises a levelling means for substantially levelling powder deposited on the operative surface.

14. The printing apparatus according to claim 13, wherein the levelling means comprises a blade that is configured to, in use, periodically scrape an uppermost surface of the powder on the operative surface.

15. The printing apparatus according to claim 13, wherein the levelling means comprises an electrostatic charging means.

16. The printing apparatus according to claim 13, wherein the levelling means comprises a vibration generation means for applying vibrational forces to particles comprised in the powder on the operative surface.

17. The printing apparatus according to claim 16, wherein the vibration generation means comprises a mechanical vibration generator.

18. The printing apparatus according to claim 16, wherein the vibration generation means comprises an ultra-sonic vibration generator.
